(19) United States
(12) Patent Application Publication
(10) Pub. No.: US 2008/0045047 A1
(43) Pub. Date: Feb. 21, 2008

(54) Electrical connector

(75) Inventors: Ming-Yue Chen, Tu-cheng (TW); Hsiu-Yuan Hsu, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/893,156

(22) Filed: Aug. 15, 2007

(30) Foreign Application Priority Data
Aug. 15, 2006 (TW) 95214352

(51) Int. Cl. H01R 12/00

(52) U.S. Cl. 439/68; 29/882

(57) ABSTRACT

An electrical connector 5 comprise an upper housing 52 defining a number of contact passageways 521, a lower housing 54 defining a number of tail passageways 541 in communicate with the contact passageways 521, a number of contacts 51 extending along the contact passageways 521 and the tail passageways 541, at least one intermediate member 53 defining a plurality of opening 531 for receiving the contacts 51 therein arranged between the upper housing 52 and the lower housing 54.

### BACKGROUND OF THE INVENTION

1. Field of the invention

The present invention relates to an electrical connector, and more particularly to an electrical connector able to providing a stable and reliable electrical transmission between a chip module and a printed circuit board.

2. Background of the invention

Electrical connectors are widely used in electrically bridge two electrical interfaces such as an electrical substrate, e.g. a PCB and an integrated circuit (IC) package, e.g. a central processing unit (CPU).

Referring to FIG. 1, a typical electrical connector 1 includes an upper housing 10, a lower housing 11, a plurality of contacts 12 received in the upper housing 10 and the lower housing 11, the upper housing 10 defines a number of passageways for receiving the contacts 12 therein, and the lower housing 11 defines a plurality of receiving holes in communicate with passageways of the upper housing 10 for receiving the contacts 12 therein too. The contact 12 is configured as C shape and comprises a base portion 120, an upper arm 121 extending from a top end of the base portion 120, a lower arm 122 extending from a lower end of the base portion 120. In addition, the upper arm 121 and the lower arm 122 each form a sharp point on an end thereof. In assembly, the upper arm 121 is inserted into the passageway of the upper housing 10 for contacting with the chip module, and the lower arm 122 is inserted into the corresponding passageway of the lower housing 11 for connecting with the printed circuit board. The contacts 12 are located in the upper and lower housings 10, 11 by the upper arms 121 engaging with the passageways of the upper housing 10 and the lower arms 122 interferentially engaging with the receiving holes of the lower housing 11.

However, in the abovementioned electrical connector 1, the contacts 12 are positioned in the housing by the interferentically engagement between the upper arm 121, the lower arm 122 and the passageways of the upper housing 10 and the lower housing 11 respectively. So, when the chip module is pressed downwardly, the center of gravity of the contact may be deflected, which leads to the contact 12 to rotate simultaneously, hence destroying the connection between the upper or lower arm 121, 122 of the contact 12 and the chip module or printed circuit board respectively. In a serous state, the open circuit may happen.

What is needed, thereby, is a new electrical connector that can be easily manufactured, and providing a stable and reliable electrical connection between the chip module and the printed circuit board.

### SUMMARY OF THE INVENTION

An electrical connection according to a preferred embodiment of the present invention may include an upper housing, a plurality of contacts, a lower housing. Each contact comprises a curved base portion, a pair of contacting portions extending from two opposite sides of the base portion. The upper and lower portion each define a plurality of passageways for receiving the contacts therein. In addition, the electrical connector further comprises a bracket between the upper housing and the lower housing with a plurality of receiving holes communicating with the passageways of the upper housing and the lower housing for receiving a center portion of the contact. In relative to the relative art, the added bracket can enforce the contacts received in the housing, which prevents the contacts from bending or breaking.

### BRIEF DESCRIPTION OF THE DRAWINGS

FIG. 1 is an isometric view of related electrical connector.

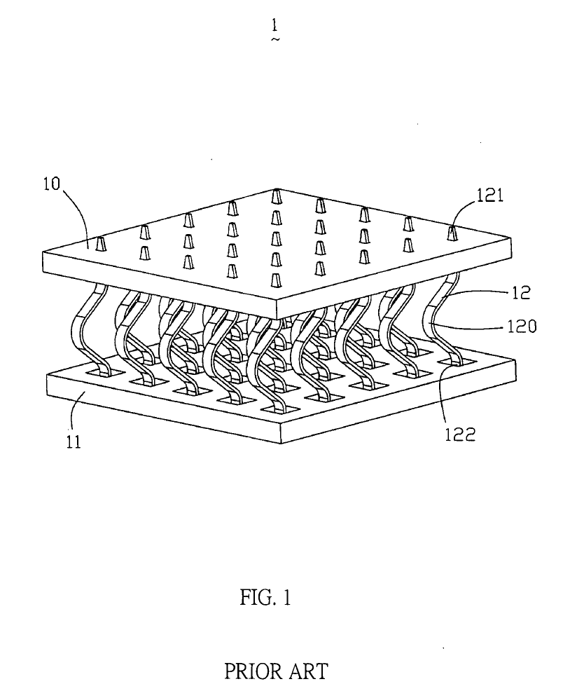

FIG. 2 is an assembled view of an electrical connector in accordance with a preferred embodiment of the present invention;

FIG. 3 is an isometric view of a conventional electrical contact; and

### DETAILED DESCRIPTION OF THE PREFERRED EMBODIMENT OF THE INVENTION

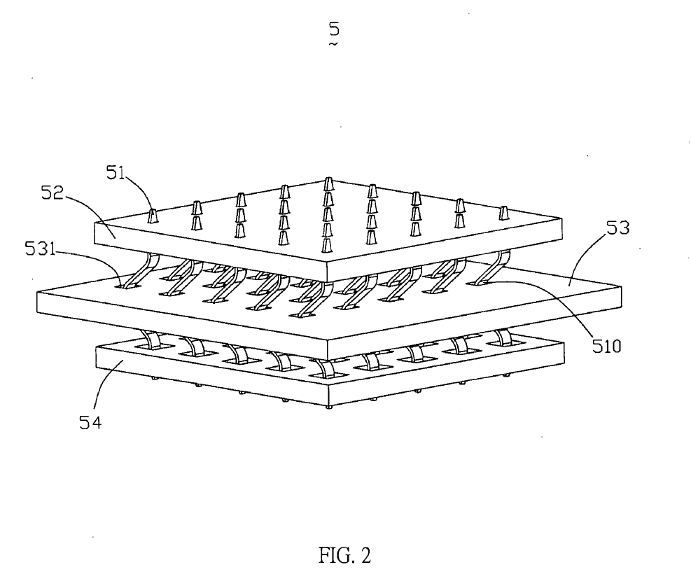

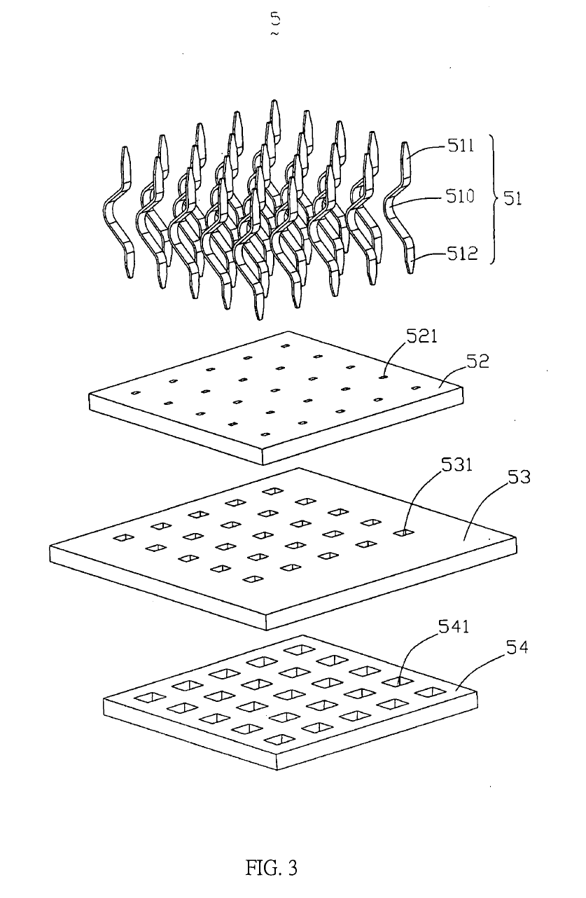

Referring to FIGS. 2-3, an electrical connector 5 according to a preferred embodiment of the present invention is shown which is mainly adapted to electrically connect two interfaces, such as an IC package and a PCB (not shown), but not limited thereto comprises an upper housing 52, a lower housing 54, a plurality of contacts 51 inserted through the upper housing 52 and lower housing 54, a intermediate member 53 disposed between the upper housing 52 and lower housing 54 for positioning and reinforcing the contacts 51 received therein.

Referring also to FIG. 2, the contact 51 is formed from conductive material and has a arched plate-like retention portion 510, a contact arm portion 511 and a tail arm portion 512 extending from two opposite ends of the retention portion 510, the contact arm portion 511 and the tail arm portion 512 each define a sharp point with rectangular shape.

The upper housing 52 is in shape of rectangular structure and comprises a number of contact passageways 521 adapted to receiving the contact arm portion 511 of the contact 51. The contact arm portions 511 engage with contact passageways 521 of the upper housing 52 with interferentially engagement. In assembly, the contact portion 511 extends through the contact passageways 521 and beyond an upper surface of the upper housing 52 for contacting with the chip module.

the lower housing 54 is configured in similar shape with the upper housing 52 and comprises a plurality of tail passageways 541 for receiving the tail arm portion 512 of the contact 51 In assembly, the contacting portion of the tail arm portion 512 is inserted into the tail passageways 541 and beyond a lower surface of the lower housing 54 for contacting with the printed circuit board. And the tail arm portion 512 is positioned in the tail passageways 541 of the lower housing 54 by an interferrentially engagement.

The intermediate member 53 is sandwiched between the upper housing 52 and the lower housing 54 and defines a number of opening 531 in communicate with the contact passageways 521 and the tail passageways 541. After assembled, the base portion 510 is partially received in the opening 531 of the intermediate member 53, and the base portion 510 of the contact 51 engages with inner walls of the opening 531 by an interferentially engagement, hence the electrical connection between the chip module and the printed circuit board bridged by the contacts 51 becomes more stable and reliable.

While preferred embodiment in accordance with the present invention have been shown and described, equivalent modifications and changes known to persons skilled in the art according to the spirit of the present invention are considered within the scope of the present invention as defined in the appended claims.

What is claimed is:

1. An electrical connector comprising:
an intermediate member defining a plurality of openings therein;
a plurality of contacts each having a middle portion received in the opening, each contact further including a contact portion and a tail portion;
an upper housing defining a plurality of first passageways which receive the contact portions; and
a lower housing defining a plurality of second passageways which receive the tail portions.

2. The electrical connector as claimed in claims 1, wherein at least one intermediate member engages with the middle portion of the contact.

3. The electrical connector as claimed in claim 2, wherein the contact arm portion and the tail arm portion respectively define a contacting portion with rectangular shape on a distal end thereof.

4. A product of a method for placing an exterior contact on an element of an electrical connector having an upper housing and a lower housing, comprising the steps of:
(a) providing a intermediate member having at least an opening therein;
(b) providing an electrical contact having a middle portion located at the opening;
(c) positioning a contact portion of the contact in a passageway of the upper housing; and
(d) positioning a tail portion of the contact in a passageway of the lower housing.

5. The product of a method for placing an exterior contact on an element of an electrical connector as claimed in claim 4, wherein the contact arm portion and the tail arm portion in steps (c) and (d) respectively are each formed in a rectangular shape on a distal end thereof.

6. An electrical connector comprising:
a plurality of contacts arranged in matrix, each defining an upper contact portion, a lower tail portion and middle portion therebetween;
an intermediate member;
an upper housing defining a plurality of first passageways respectively receiving the contact portions of the corresponding contacts; and
a lower housing defining a plurality of second passageways respectively receiving the tail portions of the corresponding contacts; wherein
the intermediate member, the upper housing and the lower housing are parallel with one another, and the middle portions of said contacts are curved along a same direction and supported by said intermediate member.

7. The connector as claimed in claim 6, wherein said the intermediate member defines a plurality of openings through which the middle portions extend, respectively.

8. The connector as claimed in claim 7, wherein said contact portion and said tail portion extend vertically.

9. The connector as claimed in claim 8, wherein said contact portion and said tail portion are aligned with each other.
